(19) United States
(12) Patent Application Publication
(10) Pub. No.: US 2002/0053794 A1
(43) Pub. Date: May 9, 2002

(54) Landing gear lift apparatus

(76) Inventor: Franklin D. Fender, Groveland, FL (US)

Correspondence Address: William M. Hobby, III, Suite 375, 157 E. New England Avenue, Winter Park, FL, 32789, US

(21) Appl. No.: 10/007,844

(22) Filed: Nov. 5, 2001

Related U.S. Application Data
(60) Provisional application No. 60/245,992, filed on Nov. 6, 2000.

(51) Int. Cl. B60S 9/02

(52) U.S. Cl. 280/766.1; 280/763.1

(57) ABSTRACT

A portable electric drive for a trailer landing gear lifting apparatus includes a trailer having a landing gear lifting apparatus having a hand crank engaging member for coupling to a portable electric drive. A base plate has an electric motor attached thereto for driving a drive shaft extending therethrough. A hand crank engaging member coupling is attached to the electric motor driven shaft and positioned to engage the hand crank engaging member. The base plate has a handle attached to one side thereof for supporting the trailer landing gear portable electric drive. A support member is attached to the trailer adjacent the landing gear hand crank engaging member and has a pair of openings therethrough having a sleeve attached to the support member over each opening. The base plate has a pair of support arms fixedly attached thereto each aligned for insertion one of the openings in the support member and into the attached sleeve for supporting and aligning the portable electric drive. The portable electric drive for a trailer landing gear is removably attachable to the landing gear hand crank engaging member and supported thereon for raising and lowering the front feet of a trailer.

### BACKGROUND OF THE INVENTION

The present apparatus relates to a landing gear for semi-trailers, utility trailers, agricultural trailers, and boat trailers which already have a hand crank for operating a jack for lifting a trailer at one end. The standard landing gear on a semi-trailer which is already mounted under the trailer is utilized by connecting the present invention to the coupling for the crank handle. A special frame is made and attached to the bottom of the semi-trailer adjacent the crank handle connection. A portable electric motor driven crank connects to the crank handle coupling to allow the motor to raise the semi-trailer to a desired position. The power for driving the electric motor can come from the truck tractor or from a separate battery provided with the portable electric motor lift.

### SUMMARY OF THE INVENTION

A portable electric drive for a trailer landing gear lifting apparatus includes a trailer having a landing gear lifting apparatus having a hand crank engaging member for coupling to a portable electric drive. A base plate has an electric motor attached thereto for driving a drive shaft extending therethrough. A hand crank engaging member coupling is attached to the electric motor driven shaft and positioned to engage the hand crank engaging member. The base plate has a handle attached to one side thereof for supporting the trailer landing gear portable electric drive. A support member is attached to the trailer adjacent the landing gear hand crank engaging member and has a pair of openings therethrough having a sleeve attached to the support member over each opening. The base plate has a pair of support arms fixedly attached thereto each aligned for insertion one of the openings in the support member and into the attached sleeve for supporting and aligning the portable electric drive. The portable electric drive for a trailer landing gear is removably attachable to the landing gear hand crank engaging member and supported thereon for raising and lowering the front feet of a trailer.

### BRIEF DESCRIPTION OF THE DRAWINGS

Other objects, features, and advantages of the present invention will be apparent from the written description and the drawings in which:

FIG. 1 is a perspective view of a semi-tractor trailer having the present landing gear lift attached;

FIG. 2 is a partial perspective view of a semi-trailer lift mechanism in accordance with the present invention;

FIG. 3 is a cut-away side elevation of the landing gear of FIG. 2;

FIG. 4 is a partial sectional view of the landing gear of FIGS. 2 and 3; and

FIG. 5 is a partial perspective view of FIG. 4 having the motorized lift coupled thereto.

### DESCRIPTION OF THE PREFERRED EMBODIMENT

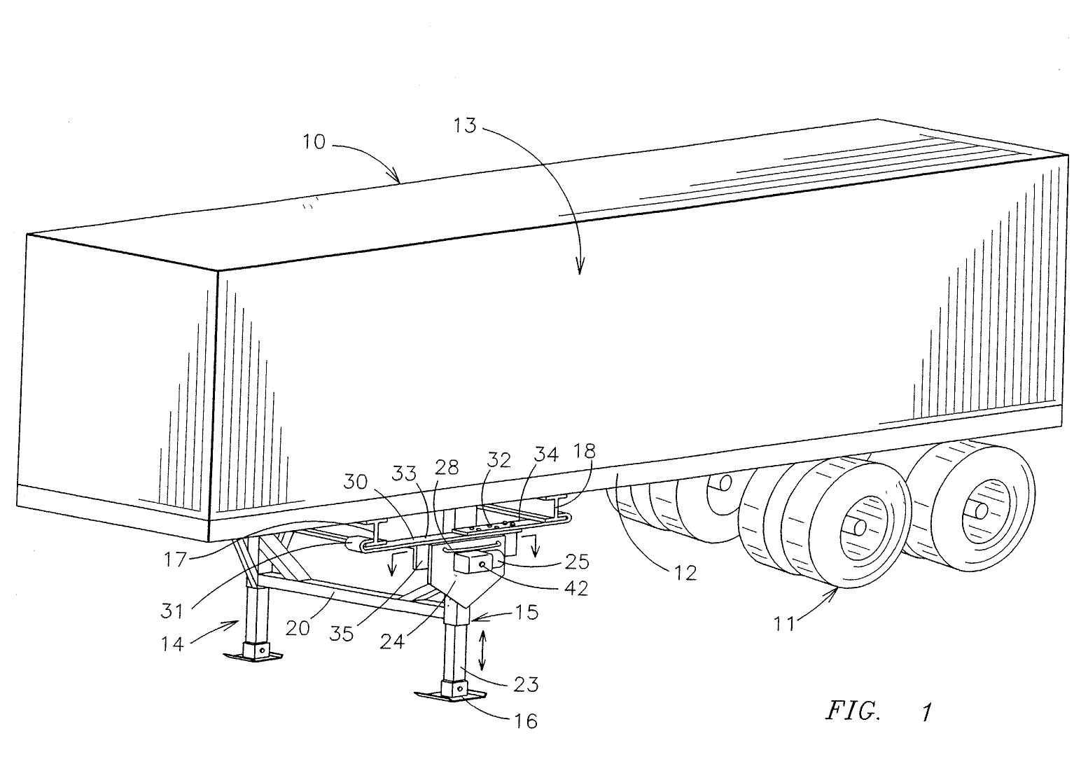

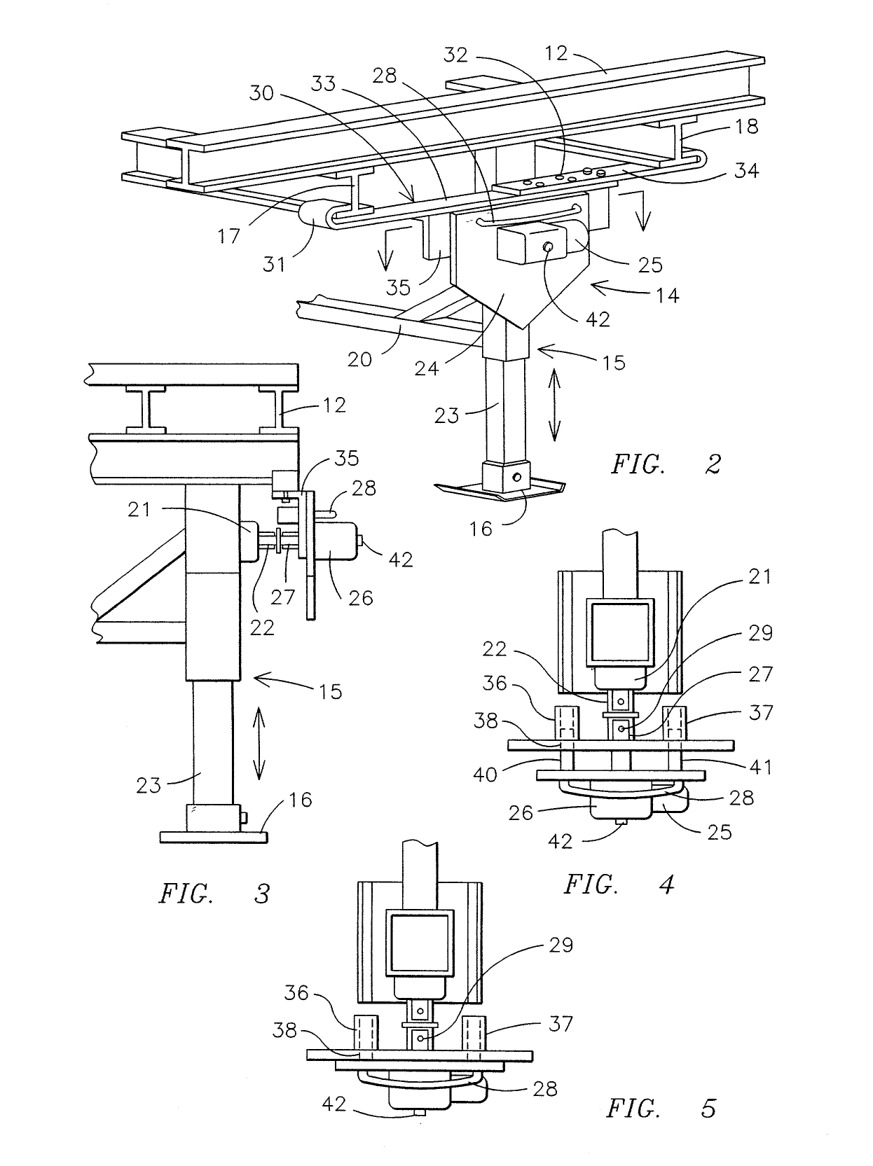

Referring to the drawings, FIGS. 1-5, a semi-trailer 10 is illustrated having a plurality of wheels 11, side rails 12 supporting the walls 13 of the trailer. The front of the semi-trailer 10 has a ground supporting system 14 for supporting the front of the trailer when it is not connected with a king pin to a fifth wheel of a truck tractor. The lifting and supporting system includes a pair of telescoping support legs 15 having a sand-shoe 16 on the bottom thereof for setting on the surface, which is supported with a pair of eye beams 17 and 18, connected across the side rails 12. Cross bracing 20 is also provided between the support legs 15. The tractor trailer normally has a manual lift 21 which has a crank handle engaging member 22 connected to gearing in the housing 21 which in turn typically drives a rack to move the telescoping leg 23 of the support legs 15 for raising or lowering the tractor trailer 10.

The present invention anticipates leaving the crank handle uncoupled from the crank handle engaging member 22. A portable lift member 23 includes a base plate 24 having an electric motor 25 attached thereto and attached through a gearing 26 to a crank engaging member 27 on the opposite side of the plate 24. The plate 24 also has a lifting handle 28 attached thereto. The underside of the tractor trailer 10 has been modified by attaching a cross-brace member 30 to the I-beams 17 and 18 using U-shaped end members 31 to attach to the bottom of each I-beam 17 and 18 and then clamped together by bolts 32 clamping sides 33 and 34 together to lock the member 30 to the I-beams 17 and 18. The support member 30 has an angle iron member 35 attached thereto and extending downward which has a pair of alignment and support sleeves 36 and 37 attached to the backside thereof and having a pair of openings 38 going through the plate 35. This allows a pair of locking bars 40 and 41 fixedly attached to the plate 24 to align with the sleeves 36 and 37 to be slid thereinto, thereby sliding the crank connector member 27 into engagement with the crank coupling 22. A quick pin 29 allows disconnection of the gear dive to allow manual turning of the crank in case of freeze up or failure of the unit. The motor can then be actuated with a switch 42 to drive the existing trailer truck crank mechanism to raise the tractor truck on the support legs 15 to a desired position. The arms 40 and 41 sliding into the sleeves 36 and 37 not only align the crank coupling 27 but also prevents the rotational forces from twisting the electric motor and lifting system while applying torque to the crank lift. It also increases the safety of the operation of the lift system which cannot then slide out of a person's hand and rotate the lifting motor and system.

It should be clear at this time that a landing gear lift for a semi-trailer has been provided which utilizes the existing hand crank lifting mechanism with a portable electric motor lifting drive. However, the present invention is not to be construed as limited to the forms shown which are to be considered illustrated rather than restrictive.

I claim:

1. A portable electric drive for a trailer landing gear lifting apparatus comprising:
a trailer having a landing gear lifting apparatus having a hand crank engaging member;
a base plate having two sides;
a reversible electric motor attached to one side of said base plate and having a drive shaft extending through said base plate;
a hand crank engaging member coupling attached to said electric motor drive shaft and positioned to engage said hand crank engaging member;
a handle attached to said one side of said base plate for supporting said trailer landing gear portable electric drive;
at least one support arm fixedly attached to said base plate other side; and
a support member attached to said trailer adjacent said landing gear hand crank engaging member and having a least one support sleeve attached thereto and positioned to receive said at least one support arm for supporting and aligning said portable electric drive when said hand crank engaging member coupling is coupled to said landing gear hand crank engaging member;
whereby a portable electric drive for a trailer landing gear is removably attachable to said landing gear hand crank engaging member and supported thereon for raising and lowering the front feet of a trailer.

2. A portable electric drive for a trailer landing gear lifting apparatus in accordance with claim 1 in which said support member has an opening therein having said support sleeve from said opening for said support arm to slide through into said support sleeve.

3. A portable electric drive for a trailer landing gear lifting apparatus in accordance with claim 2 including two support arms.

4. A portable electric drive for a trailer landing gear lifting apparatus in accordance with claim 3 including two support sleeve fixedly attached to said support member aligned to receive said two support arms.

5. A portable electric drive for a trailer landing gear lifting apparatus in accordance with claim 4 in which said support member includes an angle iron member having two opening therein and having each support sleeve attached thereover to allow each said support arm to slide through one said angle iron member opening into one said support sleeve.
